(19) United States
(12) Patent Application Publication
(10) Pub. No.: US 2004/0015356 A1
(43) Pub. Date: Jan. 22, 2004

(54) Voice recognition apparatus

(75) Inventors: Kenji Nakamura, Fukuoka-shi (JP); Hiroshi Harada, Fukuoka-shi (JP); Yoshiyuki Ogata, Tosu-shi (JP); Masakazu Tachiyama, Kasuya-gun (JP); Tatsuhiro Goto, Kasuga-shi (JP); Yasuyuki Nishioka, Dazaifu-shi (JP); Yoshiaki Kuroki, Kitakyusyu-shi (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd.

(21) Appl. No.: 10/620,499

(22) Filed: Jul. 16, 2003

(30) Foreign Application Priority Data
Jul. 17, 2002 (JP) P. 2002-208386

(51) Int. Cl. G10L 15/00

(52) U.S. Cl. 704/250

(57) ABSTRACT

The invention aims at providing voice recognition apparatus which can perform training without a speaker being conscious thereof by utilizing the fact that the name of a distant party is frequently uttered at the beginning of conversation over telephone and increase the recognition ratio and recognition speed of the speaker dependent system as the speaker uses the voice recognition apparatus. The invention includes a voice recognition processor of the speaker independent system for comparing acoustic data obtained by splitting an input sound signal with a plurality of word acoustic data and detecting word acoustic data matching the split acoustic data, wherein the voice recognition processor sequentially compares word acoustic data generated from a phoneme model with acoustic data generated from a name uttered by the speaker, and stores the acoustic data identifier corresponding to the generated acoustic data, which match the word acoustic data, as a training signal.

### BACKGROUND OF THE INVENTION

1. Field of the Invention

The present invention relates to a voice recognition system to recognize the voice of an indefinite speaker.

2. Description of the Related Art

In recent years, information processing apparatus such as a telephone set, facsimile apparatus, and car navigation apparatus which allow operation on the main unit via voice input have been manufactured. Such apparatus belong to a product group which applies the so-called voice recognition technology. The systems of voice recognition technology are roughly divided into the speaker independent system which is applied to an indefinite speaker and the speaker dependent system which is applied to a definite speaker.

The speaker independent system extracts linguistic features contained in a voice and applies a pattern recognition technology such as a neural network technology to estimate the speech contents of the speaker. However, the speech voice of a speaker has a voice quality specific to an individual. In order to secure stable recognition ratio and recognition speed for an indefinite speaker, sophistication of the CPU used and an increase in the capacity of the memory are necessary, which results in a higher product cost.

On the other hand, the speaker dependent system requires the voice quality of the speaker to be registered (training) at initial use of the apparatus. Therefore, the speaker dependent system is less convenient to the speaker than the speaker independent system. However, the speaker dependent system provides apparatus which assures higher recognition ratio and recognition speed at a lower cost. In this way, these systems have their strong points and shortcomings. The larger the number of words to be recognized becomes, the more sophisticated CPU and the larger-capacity memory are required.

In the voice recognition process, the basic operation is to identify a word corresponding to a word the speaker has uttered from among the word group stored in the form of database into voice recognition apparatus and return the result to the speaker.

FIG. 9 is a block diagram showing related art voice recognition apparatus using the speaker dependent system. FIG. 10 is a block diagram showing the voice recognition processor in FIG. 9. FIG. 11 is a block diagram showing the word acoustic data storage section in FIG. 10. Operation of the voice recognition apparatus thus configured is described below.

A word uttered by the speaker is converted to an electric signal by a microphone 1 and input to a signal processor 5. The signal processor 5 converts the input sound signal to a sound signal in the form appropriate for processing in a voice recognition processor 6. In the voice recognition processor 6, a sound processor 7 extracts an acoustic feature amount from the sound signal output by the signal processor 5 and outputs the extracted acoustic feature amount as acoustic data to a word identification section 9. The word identification section 9 retrieves acoustic data which best matches the input acoustic data from the acoustic data previously stored in a word acoustic data storage section 8. As a result, a word identifier associated with the matching acoustic data is returned as identification information to the signal processor 5.

The signal processor 5 recognizes the word uttered by the speaker by way of the identification information as a result of voice recognition, and executes appropriate processing control of the apparatus and feeds back the recognition result to the speaker via a display unit 4 based on the word. An input unit 3 is a general input unit for a speaker to perform key inputs to check the recognition result and control the entire system.

As mentioned above, word acoustic data is generated through training in the speaker dependent system. Thus, in the initial state of the apparatus, word acoustic data is not yet defined so that this training is mandatory before a voice recognition process. The training is a process where a speaker utters all the words to be recognized and registers the words into the word acoustic data storage section 8. In the training process, a specific word to be recognized which was uttered by the speaker is input from the microphone 1 and converted to a sound signal by the signal processor 5. In this practice, a word identifier to discriminate between individual words to be recognized is added. The sound signal from the signal processor 5 is converted to acoustic data by the sound processor 7 and supplied to the word acoustic data storage section 8 as word acoustic data 11 together with the word identifier 10. The word acoustic data storage section 8 stores the word acoustic data 11 and the word identifier 10 in association with each other. By repeating this training process for all the words to be recognized, voice recognition is made possible.

An example of the speaker independent system is described below. FIG. 12 is a block diagram showing related art voice recognition apparatus using the speaker independent system. FIG. 13 is a block diagram showing the word voice recognition processor in FIG. 12. FIG. 14 is a block diagram showing the word dictionary storage section in FIG. 13. In the voice recognition according to the independent speaker system, no data is stored in a word dictionary storage section 12. The speaker must use an input unit 3 to input word data before operating the voice recognition apparatus. The input word data is input to a signal processor 5, where a word identifier is added to the word data. Then, the word data is input to the word dictionary storage section 12 of a voice recognition processor 6 and retained therein.

A word uttered by the speaker is converted to a sound signal in the form appropriate for processing in the voice recognition processor 6. A sound processor 7 extracts an acoustic feature amount from the sound signal and outputs the extracted acoustic feature amount as acoustic data to a word identification section 9. In a phoneme model storage section 13, a phoneme model tailored to a language typically used is stored as phoneme data. At the same time as recognition operation is started, the phoneme data is input to a language model generation and storage section 14.

The language model generation and storage section 14 generates word acoustic data from the input word data and phoneme data and outputs the word acoustic data together with a word identifier to a word identification section 9. This process is repeated for all the word data stored in the word dictionary storage section 12. The word identification section 9 retrieves word acoustic data which best matches the input word acoustic data from the word acoustic data sequentially generated in the language model generation and storage section 14. As a result, a word identifier associated with the matching word acoustic data is returned as identification information to the signal processor 5. The signal processor 5 recognizes the word uttered by the speaker by way of the identification information as a result of voice recognition, and executes appropriate processing control of the apparatus and feeds back the recognition result to the speaker via a display unit 4 based on the word.

While the voice recognition apparatus according to the related art speaker independent system is advantageous in that it does not require training work, the voice recognition apparatus provides lower recognition ratio and recognition speed. The voice recognition apparatus generates word acoustic data from a phoneme model for each word dictionary. This requires higher processing speed and a larger memory capacity, thus resulting in a higher cost. While the aforementioned speaker dependent system is advantageous in that it provides higher recognition ratio and recognition speed, it requires training work, which is burdensome to the speaker. In this way, both systems have their strong points and shortcomings and have problems such as poor convenience.

### SUMMARY OF THE INVENTION

The invention, in view of the related art problems, aims at providing voice recognition apparatus which can perform training without a speaker being conscious thereof by utilizing the fact that the name of a distant party is frequently uttered at the beginning of conversation over telephone and increase the recognition ratio and recognition speed of the speaker dependent system as the speaker uses the voice recognition apparatus.

### BRIEF DESCRIPTION OF THE DRAWINGS

FIG. 1 is a block diagram showing voice recognition apparatus according to Embodiment 1 of the invention;

FIG. 2 is a block diagram showing the voice path section of the signal processor of the voice recognition apparatus according to Embodiment 4 of the invention;

FIG. 3 is a block diagram showing the voice path section of the signal processor of the voice recognition apparatus according to Embodiment 4 of the invention;

FIG. 4 is a data diagram showing a general example of word data in a word dictionary storage section;

FIG. 5 is a data diagram showing the arrangement of word data according to Embodiment 6 of the invention;

FIG. 6 is a data diagram showing a case where the first character of a family name is stored separately from the other section of the family name and a first name;

FIG. 7 is a data diagram showing the word data arrays in the word dictionary storage section in the descending order of use frequency;

FIG. 8 is a block diagram showing voice recognition apparatus according to Embodiment 15 of the invention;

FIG. 9 is a block diagram showing related art voice recognition apparatus using the speaker dependent system;

FIG. 10 is a block diagram showing the voice recognition processor in FIG. 9;

FIG. 11 is a block diagram showing the word acoustic data storage section in FIG. 10;

FIG. 12 is a block diagram showing related art voice recognition apparatus using the speaker independent system;

FIG. 13 is a block diagram showing the voice recognition processor in FIG. 12; and

FIG. 14 is a block diagram showing the word dictionary storage section in FIG. 13.

### DETAILED DESCRIPTION OF THE PREFERRED EMBODIMENTS

The embodiments of the invention are described below referring to the drawings.

(Embodiment 1)

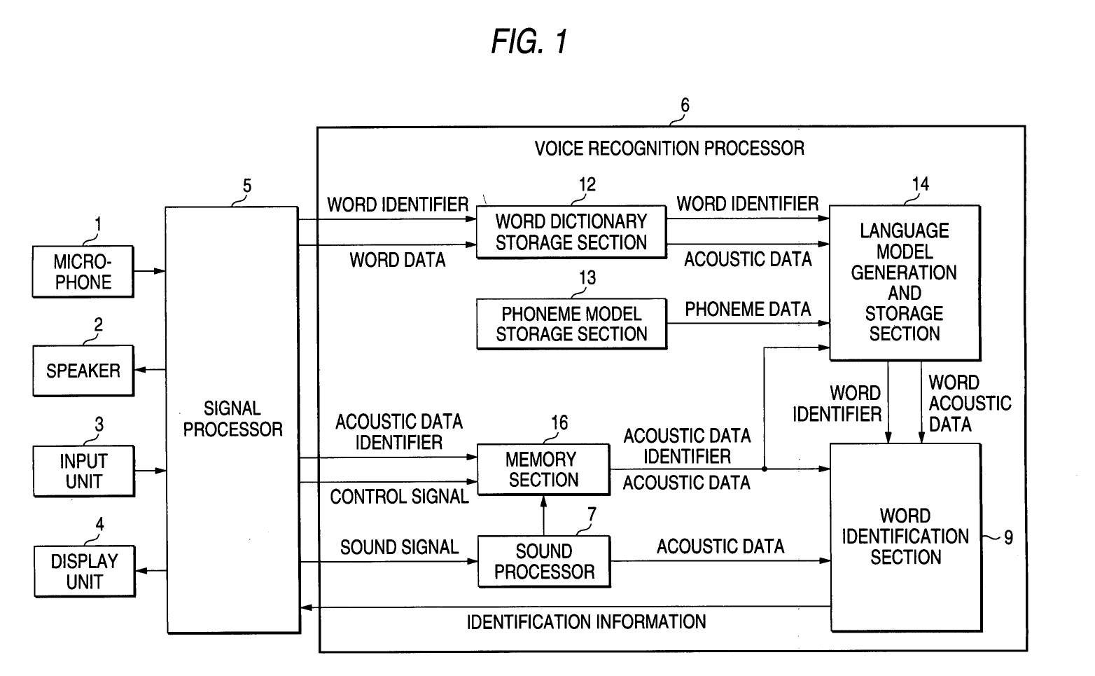

FIG. 1 is a block diagram showing voice recognition apparatus according to Embodiment 1 of the invention. FIG. 1 shows voice recognition apparatus according to the speaker independent system.

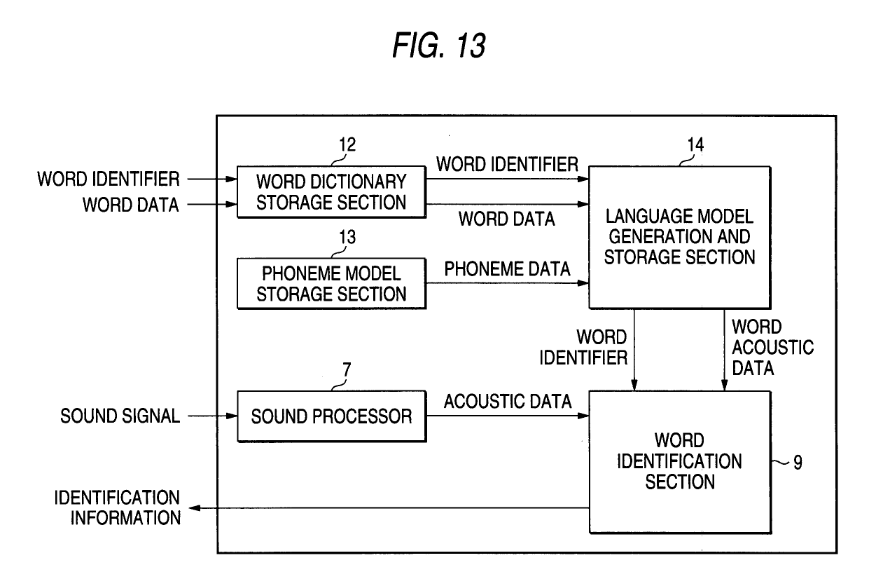

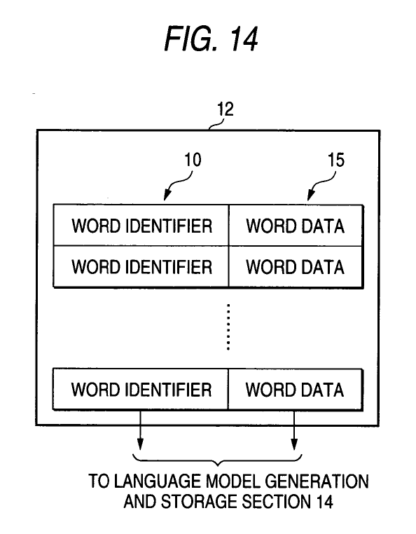

In FIG. 1, a microphone 1, a speaker 2, an input unit 3, a display unit 4, a signal processor 5, a voice recognition processor 6, a sound processor 7, a word identification section 9, a word dictionary storage section 12, a phoneme model storage section 13, and a language model generation and storage section 14 are same as those in FIG. 12 and FIG. 13. Thus, the same numerals are assigned to these components and corresponding description is omitted. A numeral 16 represents a memory section storing an acoustic data identifier and acoustic data.

Automatic training on the voice recognition apparatus is thus configured without the speaker being conscious is described below, taking a telephone set as an example.

In general, when a speaker makes a call to another person, the frequency of the name of the distant party being uttered at the beginning of conversation is very high. For example, in Japanese, “Moshi moshi Nakamura desu ga, Matsushita san o, onegai shimasu.” or in English, “Hellow. This is Nakamura. Mr. Matsushita, please.”

Operation of the voice recognition section in the case of this example is described below. First, as shown in FIG. 1, a sound signal carrying the sentence “Moshi moshi Nakamura desu ga, Matsushita san o, onegai shimasu.” is input to a signal processor 5 from a microphone 1. A sound processor 7 which has input this sound signal splits the voice “Moshi moshi Nakamura desu ga, Matsushita san o, onegai shimasu.” into acoustic data “Moshi” “moshi” “Naka” “mura” “desu” “ga,” “Matsu” “shita” “san” “o,” “one” “gai” “shima” “su.” with arbitrary time intervals. The sound processor 7 then outputs the resulting acoustic data (word acoustic data) to a memory section 16.

To each split item of acoustic data, an acoustic data identifier is assigned by the signal processor 5. The memory section 16 associates the acoustic data generated in the sound processor 7 with the acoustic data identifier input from the signal processor 5 and stores the acoustic data. Next, the memory section 16 outputs the stored acoustic data and the corresponding acoustic data identifier to a word identification section 9.

Meanwhile, in a word dictionary storage section 12, the word data “Matsushita” corresponding to the distant party of the call is already known from the directory database the speaker accessed during call origination. The word dictionary storage section 12 outputs the word data “Matsushita” and the word identifier to discriminate the word to a language model generation and storage section 14. At the same time, phoneme data is output to the language model generation and storage section 14 from the phoneme model storage section 13. The word acoustic data is generated in the language model generation and storage section 14, and is output together with a word identifier to the word identification section 9.

The word identification section 9 compares the word acoustic data “Matsushita” output from the language model generation and storage section 14 with the acoustic data “Moshi” “moshi” “Naka” “mura” “desu” “ga,” “Matsu” “shita” “san” “o,” “one” “gai” “shima” “su.” Then, the word identification section 9 outputs the acoustic data identifier of “Matsu” “shita” with high degree of coincidence as identification information to the signal processor 5.

The signal processor 5 outputs the acoustic data identifier of “Matsu” “shita” with high degree of coincidence and a control signal to the memory section 16. The memory section 16, receiving the acoustic data identifier and the control signal, outputs the acoustic data identifier and the corresponding acoustic data to the language model generation and storage section 14. The language model generation and storage section 14 replaces the input acoustic data identifier with an arbitrary identifier and stores the acoustic data so that the data is combined as a sequence of data in time.

In the case that the speaker utters the word “Matsushita” the next time, the language model generation and storage section 14 first outputs the stored word acoustic data and the word identifier to the word identification section 9 for recognition operation. When an arbitrary degree of coincidence is obtained, the word identification section 9 outputs the identification information including the word identifier to the signal processor, which outputs the information to the display unit 4. For a degree of coincidence below the arbitrary degree of coincidence, word acoustic data is generated based on a related art phoneme model so tat the processing turns complicated.

In this way, it is possible to provide voice recognition apparatus according to the speaker independent system which attains higher recognition ratio and recognition speed as the speaker uses the voice recognition apparatus, thus provides the speaker with excellent convenience.

(Embodiment 2)

The configuration of voice recognition apparatus according to Embodiment 2 of the invention is shown in FIG. 1, same as Embodiment 1.

As described referring to Embodiment 1, it become possible to increase the recognition ratio and recognition speed on voice recognition apparatus of the speaker independent system. However, the process of splitting the sentence of the speaker “Moshi moshi Nakamura desu ga, Matsushita san o, onegai shimasu.” into acoustic data “Moshi” “moshi” “Naka” “mura” “desu” “ga,” “Matsu” “shita” “san” “o,” “one” “gai” “shima” “su.” requires a high throughput of the apparatus. Small built-in apparatus could adversely affect the processing speed. To solve this problem, word which precedes and follows the name of a distant party are previously registered focusing on the regularity of the appearance of the words. The word which precedes is assumed as a start signal, and the word which follows is assumed as an end signal. This further enhances the accuracy of training and processing speed. The operation is described below.

Same as Embodiment 1, the sentence “Moshi moshi Nakamura desu ga, Matsushita san o, onegai shimasu.” is taken as an example. In FIG. 1, the sound signal “Moshi moshi Nakamura desu ga, Matsushita san o, onegai shimasu.” is input to the signal processor 5 from the microphone 1. The signal processor 5 splits the voice “Moshi moshi Nakamura desu ga, Matsushita san o, onegai shimasu.” into acoustic data “Moshi” “moshi” “Naka” “mura” “desu” “ga,” “Matsu” “shita” “san” “o,” “one” “gai” “shima” “su.” with arbitrary time intervals, and outputs the resulting acoustic data to the memory section 16.

An acoustic data identifier is assigned to each split item of acoustic data by the signal processor 5. The memory section 16 associates the acoustic data generated in the sound processor 7 with the acoustic data identifier input from the signal processor 5 and stores the acoustic data. Next, the memory section 16 outputs the stored acoustic data and the corresponding acoustic data identifier to the word identification section 9.

Here, words which tend to precede or follow the name of the distant party, such as a particle typified by “ga” and a title of respect typified by “san”, are previously registered into the word dictionary storage section 12 and generated and stored in the language model generation and storage section 14 together with the phoneme data output from the phoneme model storage section 13.

When the acoustic data “ga” is input to the word identification section 9 from the memory section 16, the word identification section 9 performs identification operation by using the word acoustic data generated and stored in the language model generation and storage section 14 and the acoustic data. In the case that a result equal to or higher than an arbitrary degree of coincidence is obtained, the word identification section 9 outputs identification information to the signal processor 5. The signal processor 5 compares the word identifier registered as a start signal with a recognition signal. In the case that a match is found, the signal processor 5 stores the recognition signal as the start signal. The signal processor 5 performs the same processing for the end signal. This identifies the characters “ga” and “san” preceding and following “Matsushita” used for training. The signal processor 5 outputs to the memory section 16 a control signal to output acoustic data after the start signal and before the end signal to the language model generation and storage section 14.

Therefore, the acoustic data of “Matsushita” output from the memory section 16 are stored into the language model generation and storage section 14. As a result, an advantage similar to that of Embodiment 1 is obtained and it is possible to provide voice recognition apparatus which assures higher training accuracy and processing speed than that of Embodiment 1.

(Embodiment 3)

While the start signal is detected based on a particle and training is performed in Embodiment 2, there exist various types of particles and registration requires large memory quantity. To solve this problem, a dead time exists before a name to be trained especially in the Japanese language. By recognizing the dead time and using it as a start signal, training with higher accuracy is performed. Configuration and operation of this embodiment are the same as those of Embodiment 2. Dumb word data is registered in the word dictionary storage section 12 and dumb word acoustic data is generated and stored in the language model generation and storage section 14. In the example of “Moshi moshi Nakamura desu ga, Matsushita san o, onegai shimasu.”, even in the case that a dead space is inserted next to “Moshi moashi”, “Moshi moshi” to be as a start signal, “Nakamura desu ga,” as a start signal, “Matsushita san” as an end signal, “o,” as a start signal, and “onegai shimasu.” as a start signal. When attention is focused on the signals alone, the sequence of “a start signal→a start signal→an end signal→a start signal→a start signal” is detected. When a sequence of “a start signal→a start signal” and a sequence of “an end signal→a start signal” are neglected and a sequence of “a start signal→an end signal” is detected by the signal processor 5, training is made possible.

In this way, it is possible to provide voice recognition apparatus which enhances the accuracy of training and reduces the memory amount of the word dictionary storage section 12 and the language model generation and storage section 14.

(Embodiment 4)

While detection of the dead time is made by the voice recognition processor 6 in Embodiment 3, software processing made on apparatus must be reduced in order to support apparatus with lower processing ability. To solve this problem, a detection section is provided in the signal processor 5 to perform hardware-based detection, thereby reducing the overall load on the apparatus and provides higher recognition speed.

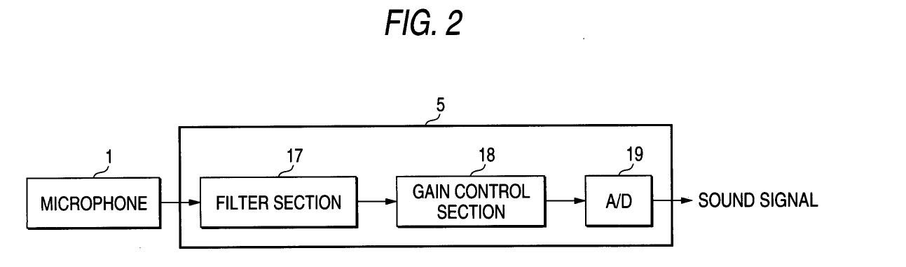

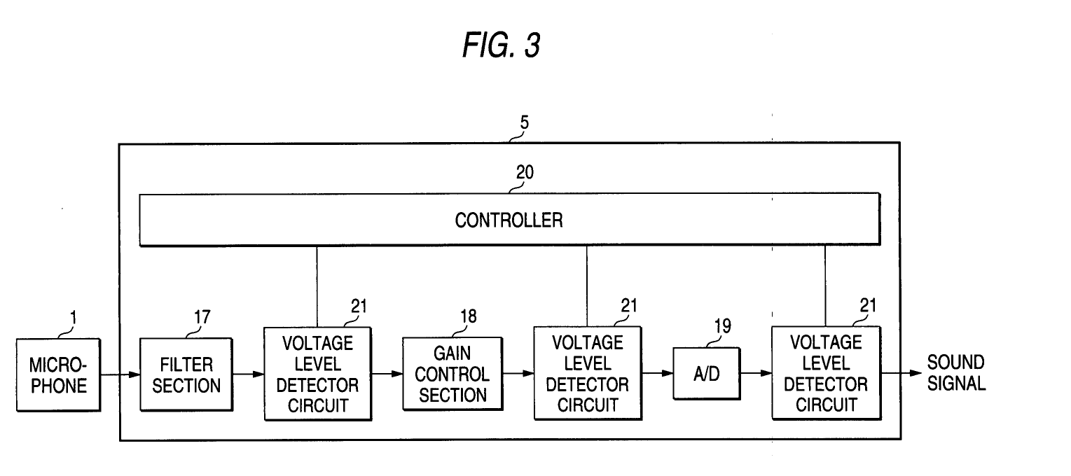

FIGS. 2 and 3 are block diagrams each showing the voice path section of the signal processor 5 of the voice recognition apparatus according to Embodiment 4 of the invention.

In FIGS. 2 and 3, a numeral “17” represents a filter section, “18” represents a gain control section, “19” represents an A/D converter, “20” represents a controller, and “21” represents a voltage level detector circuit.

Operation of the voice recognition apparatus thus configured is described below.

The voice input to the microphone 1 is input as an analog sound signal to the filter section 17. Unwanted signal components are removed from the voice then the resulting voice is input to the gain control section 18. The voice is adjusted to an arbitrary level in the gain control section 18 and input to the A/D converter 19. The voice is converted to a digital sound signal in the A/D converter 19 and input to the sound processor 7 in the next stage. In this embodiment, as shown in FIG. 3, the voltage level detector circuit 21 is provided between the filter section 17 and the gain control section 18 or between the gain control section 18 and the A/D converter 19, or after the A/D converter 19 to detect the dumb level and output a detection signal to the controller 20. The controller 20 receives a detection signal output from the voltage level detector circuit 21 and outputs a signal to the memory section 16. The subsequent operation is the same as that of Embodiment 3.

In this way, it is possible to provide voice recognition apparatus which features higher recognition speed with lower processing ability.

(Embodiment 5)

While a start signal is detected by way of hardware to reduce the processing load on the apparatus, the detection process is based on hardware so that the detection of the surrounding noise may be erroneous. In this embodiment, the analog section of the voltage level detector circuit 21 has a threshold value of the detected voltage, and the digital section has an arbitrary value. Only in the case that a voltage equal to or greater than the threshold value or the arbitrary value is detected, a detection signal is output to the controller 20.

This provides voice recognition apparatus which features enhanced noise immunity.

(Embodiment 6)

Embodiments 1 through 5 features the convenience for the speaker by improving the recognition ratio and recognition speed of the speaker or training accuracy However, it is necessary to boost the recognition speed for apparatus provided with lower processing capability. In this Embodiment 6, in order to solve this problem, the storage method of the word dictionary storage section 12 is improved and the identification speed of the word identification section 9 is increased to upgrade the convenience to the speaker. Configuration and operation of this embodiment are the same as those of Embodiment 1. Configuration of the word dictionary storage section 12 and its method for reading words are described below.

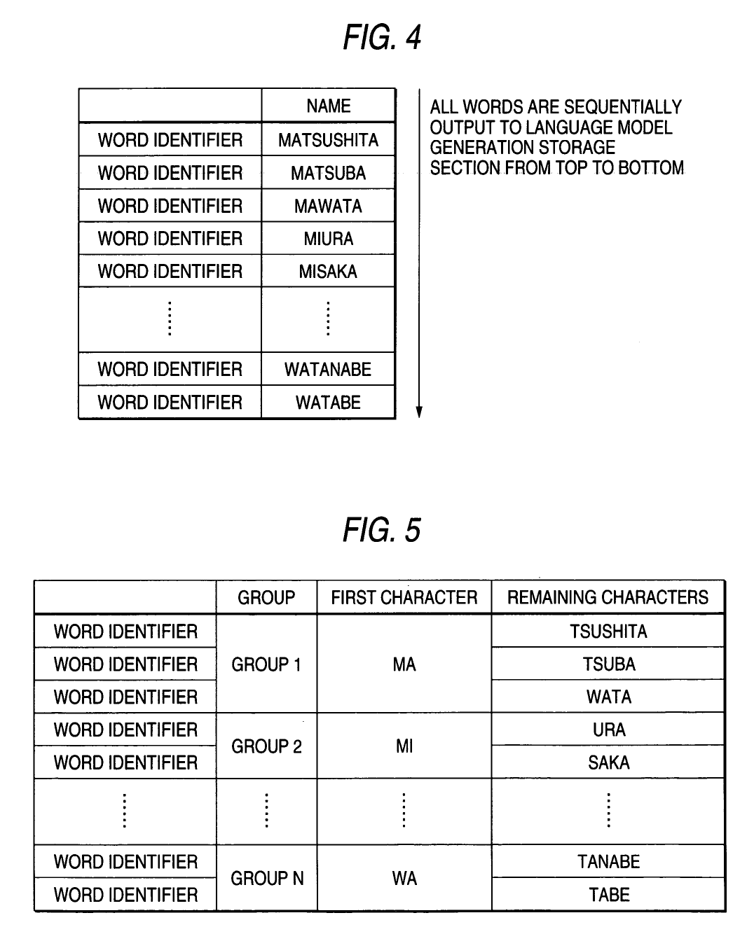

FIG. 4 is a data diagram showing a general example of word data in the word dictionary storage section 12. A name registered by the speaker is stored in each word. As recognition operation proceeds, all the names are output sequentially from the top to the language model generation and storage section 14.

FIG. 5 is a data diagram showing the arrangement of word data in Embodiment 6 of the invention. In FIG. 5, the first section of a word and the remaining section are separately stored and words beginning with the same first character are grouped together. A series of operation is described below referring to FIG. 1. In the case that the speaker has uttered for example “Matsushita” on the microphone 1, that voice undergoes various types of processing and input to the word identification section 9. Accordingly, acoustic data is sequentially output from the word dictionary storage section 12. At first, only the first character is output and input to the language model generation and storage section 14. The language model generation and storage section 14 generates word acoustic data of the first character alone based on the phoneme data output from the phoneme model storage section 13 and outputs the resulting data to the word identification section 9. The language model generation and storage section 14 can generate word acoustic data in a short time because the acoustic data is for only one character. The word identification section 9 identifies the acoustic data from the sound processor 7 and outputs a word identifier as identification information. The signal processor 5, which received the word identifier, outputs a group number determined from the identification information to the word dictionary storage section 12. The word dictionary storage section 12 outputs word data of a specific group number to the language model generation and storage section 14.

As mentioned above, a specific group registered in the word dictionary storage section 12 is generated into acoustic data. This provides voice recognition apparatus which enhances the recognition speed and reduces the memory amount of the word dictionary storage section 12 by way of a specific method for storing names.

(Embodiment 7)

Acoustic data is identified by reading the first character from the word dictionary storage section 12 in Embodiment 6. In Embodiment 7, word acoustic data of the first character is previously generated from the first character and phoneme model in the word dictionary storage section 12 and stored into the language model generation and storage section 14. This saves the time required to call word data from the word dictionary storage section 12, to call phoneme data from the phoneme model storage section, and to generate word acoustic data based on these data, thereby further boosting the processing speed.

(Embodiment 8)

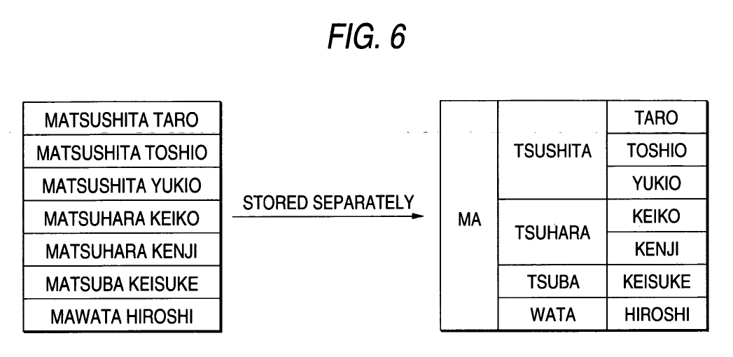

While only the first character is stored into the word dictionary storage section 12 in Embodiment 6, names registered in the word dictionary storage section 12 includes family names and first names, which may increase the memory amount. Operation of Embodiment 8 which solves the problems is described below using FIG. 6. FIG. 6 is a data diagram showing a case where the first character of a family name is stored separately from the other section of the family name and a first name.

As shown in FIG. 6, by storing the first character of a family name separately from the other section of the family name and a first name, it is possible to provide voice recognition apparatus which further reduces the memory amount.

(Embodiment 9)

According to the method for calling acoustic data from the word dictionary storage section 12 in Embodiment 1, data is read simply for all the addresses of the word dictionary storage section 12, from the highest address to the lowest address, or from the lowest address to the highest address, and acoustic data which has never been used is also prepared in the form of a language model for identification. This requires high processing ability and plenty of time. To solve this problem, information on the degree of coincidence contained in the identification information generated and output in the identification operation by the word identification section 9 is utilized. A frequency “1” is given only to the word data having the word identifier whose degree of coincidence is highest and added up each time the data is used. Then, the frequency information is stored and stored into the signal processor 5. Based on the stored frequency information, word data stored in the memory (not shown) of the word dictionary storage section 12 is arranged in the descending order of frequency. During the next identification operation, the data is output to the language model generation and storage section 14 in the descending order of frequency, converted to word acoustic data, then undergoes identification in the word identification section 9. The word identification section 9 outputs the identification information. The signal processor 5 monitors the coincidence in the input identification information and, in the case that the coincidence has dropped below an arbitrary coincidence, the display unit 4 displays a word in accordance with a word identifier stored as identification information.

The word data is identified from the beginning with the word which is used most frequently. Moreover, the frequency of word data displayed is provided with a threshold value. This provides voice recognition apparatus which allows faster recognition operation.

(Embodiment 10)

Selection of a word for display is made based on the degree of coincidence in Embodiment 9. In this embodiment, the use frequency itself is given a threshold value and word data below an arbitrary value is not output to the language model generation and storage section 14, thereby providing voice recognition apparatus which boosts recognition operation.

(Embodiment 11)

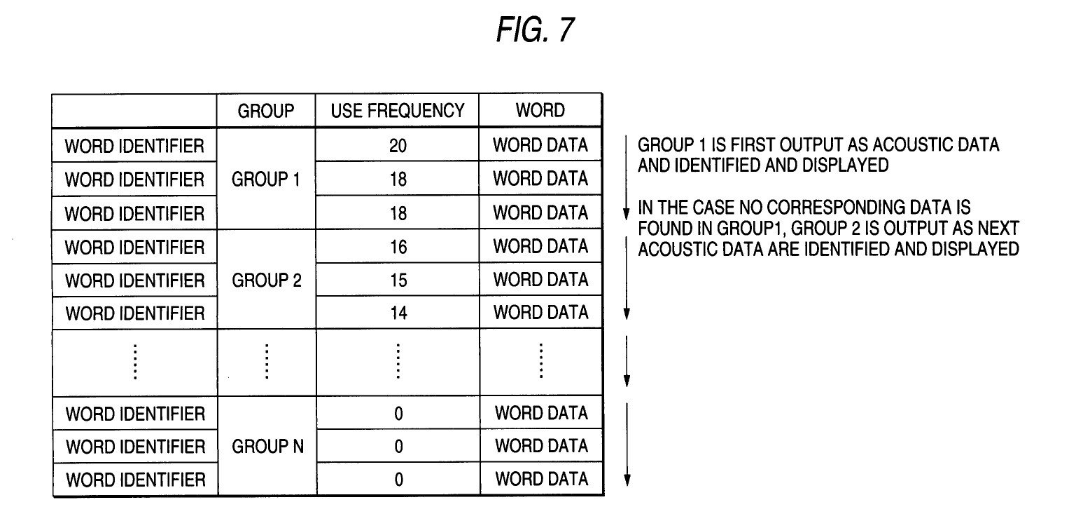

In Embodiment 9 and Embodiment 10, in the case that the use frequency of the apparatus is low, word data registered may not be displayed. To solve this problem, word data is split into blocks of arbitrary number of words in the descending order of use frequency. Acoustic data is output from the beginning with the block with highest frequency and displays block by block. This provides voice recognition apparatus which assures display of input voice data with low frequency. FIG. 7 is a data diagram showing the word data arrays in the word dictionary storage section 12 in the descending order of use frequency.

(Embodiment 12)

In Embodiment 9, Embodiment 10 and Embodiment 11, in the case that there is word data used frequently in the past but rarely used currently, the target word the speaker intends cannot be promptly displayed. To solve this problem, by incorporating a clock feature into the signal processor 5 and word data with high frequency for which an arbitrary time has elapsed is rearranged with reduced frequency, thereby providing voice recognition apparatus which excellently assures higher processing speed and convenience.

(Embodiment 13)

Both in the speaker independent system and the speaker independent system, for voice recognition apparatus in general, recognition error concerning a specific word tends to take place over and over again. To solve this problem, this embodiment uses the memory of the signal processor 5 to skip displaying for a word once erroneously recognized. This operation is described below. Configuration of voice recognition apparatus according to this embodiment is the same as that in FIG. 1.

Referring to FIG. 1, a voice is input to the microphone 1 and an analog sound signal is input to the signal processor 5. The analog sound signal finally undergoes A/D conversion in the signal processor 5, and output as a digital sound signal to the sound processor 7. In the meantime, the sound signal is stored in the memory of the signal processor 5. As the subsequent operation, a series of operation described in Embodiment 1 is performed, where the word identification section 9 outputs identification information including a word identifier to the signal processor 5. The signal processor 5 stores the identification information including the word identifier in association with the sound signal previously stored in memory. Based on the identification information, word data is displayed on the display unit 4. In case a word, which is not intended by the speaker, is displayed on the display unit 4, the speaker erases the display with the input unit 4. With this operation, even if the signal processor 5 recognizes that the identification information and the word identifier stored in memory are erroneous, the identification information is stored in association with the identification information and the word identifier previously stored. Next, in the case that the speaker has uttered the same word as the previous on another occasion, the sound signal undergoes A/D conversion same as the previous case and the resulting digital signal is stored in the memory of the signal processor 5. In this practice, the signal processor 5 determines whether the digital signal is the same as the sound signal previously stored. At the same time, the sound signal is output to the sound processor 7, and after a series of operation, the identification information including the word identifier is output from the word identification section 9. The signal processor 5 recognizes the word identifier and determines that recognition error is committed again in the case that the word identifier is the same as that stored previous time. The signal processor 5 does not display the word data corresponding to the word identifier but displays word data which is based on the word identifier included in the next received identification information on the display unit 4.

In this way, it is possible to provide excellent voice recognition apparatus which conveniently skips displaying a word which the voice recognition apparatus has determined the speaker once erroneously recognized.

(Embodiment 14)

While the memory of the signal processor 5 is used in Embodiment 13, the signal processor 5 uses memory for a variety of control such as display on the display unit 4 and monitor of the input unit 3, so that the memory of the signal processor 5 may be insufficient in regard of capacity. To solve the problem, this embodiment uses the memory section 16 connected to the sound processor 7 to obtain the same advantage as Embodiment 13. This operation is described below. Configuration of voice recognition apparatus according to this embodiment is the same as that in FIG. 1.

A voice is input to the microphone 1 and an analog sound signal from the microphone 1 is input to the signal processor 5. The analog sound signal finally undergoes A/D conversion in the signal processor 5, and output as a digital sound signal to the sound processor 7. The feature amount is extracted from the sound signal in the sound processor 7. The feature amount is output to the memory section 16 and the word identification section 9. The memory section 16 stores the feature amount. As the subsequent operation, a series of operation described in Embodiment 1 is performed, where the word identification section 9 outputs identification information including a word identifier to the signal processor 5. The signal processor 5 displays word data on the display unit 4 based on the identification information. In the case that a word, which is not intended by the speaker, is displayed on the display unit 4, the speaker erases the display with the input unit 4. With this operation, even if the signal processor 5 recognizes that the identification information and the word identifier stored in the memory section 16 are erroneous, and stores that information. Next, in the case that the speaker has uttered the same word as the previous on another occasion, the sound signal undergoes A/D conversion same as the previous case and the resulting digital signal is stored in the memory section 16. The signal processor 5 determines whether the acoustic data previously stored is the same as the acoustic data stored this time. In this example, the same word is uttered so that the signal processor determines that both acoustic data are the same. After a series of operation, the identification information including the word identifier is output from the word identification section 9. The signal processor 5 recognizes the word identifier and determines that recognition error is committed again in case the word identifier is the same as that stored previous time. The signal processor 5 does not display the word data corresponding to the word identifier but displays word data which is based on the word identifier included in the next received identification information on the display unit 4.

In this way, an advantage same as that in Embodiment 13 is obtained. It is possible to provide excellent voice recognition apparatus which reduces the load on the signal processor 5 and uses the less-capacity memory to process data from which the feature amount has been removed.

(Embodiment 15)

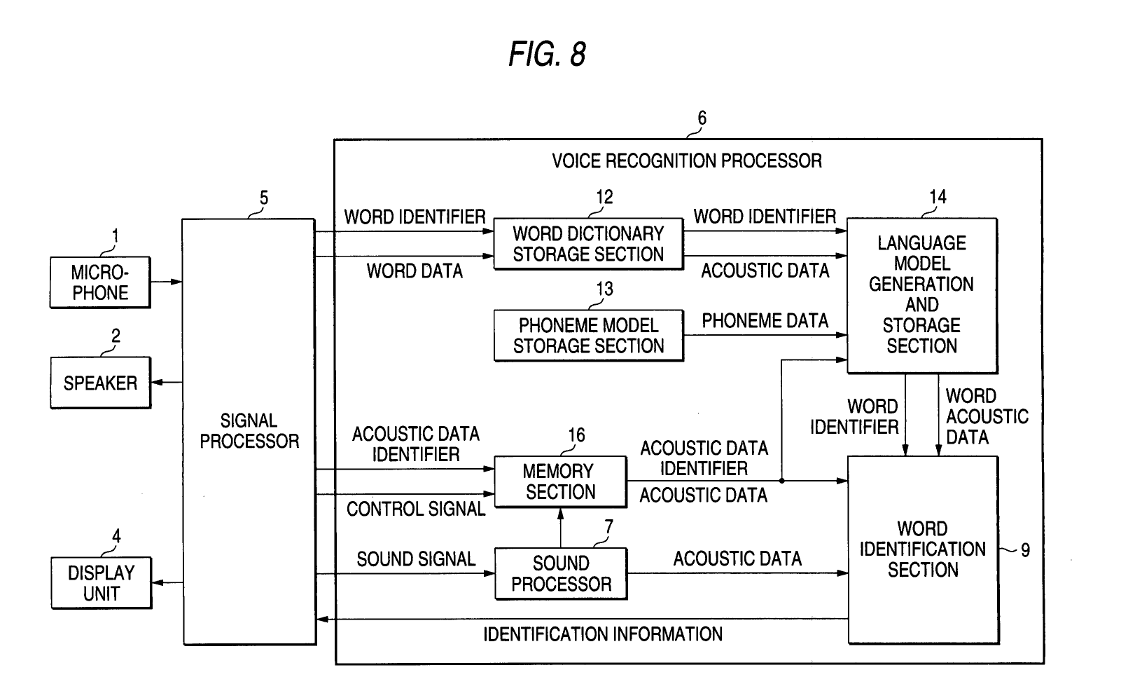

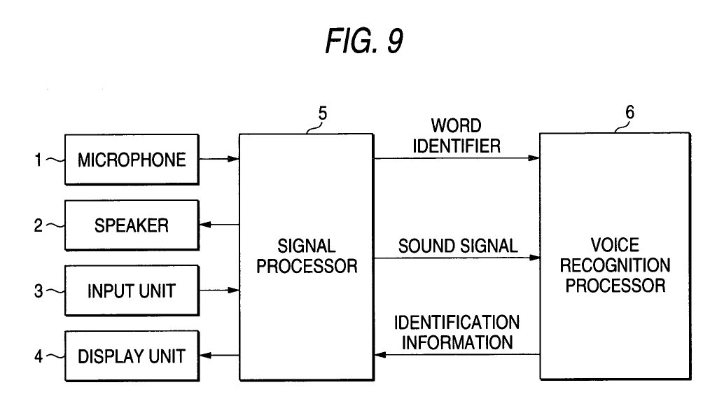

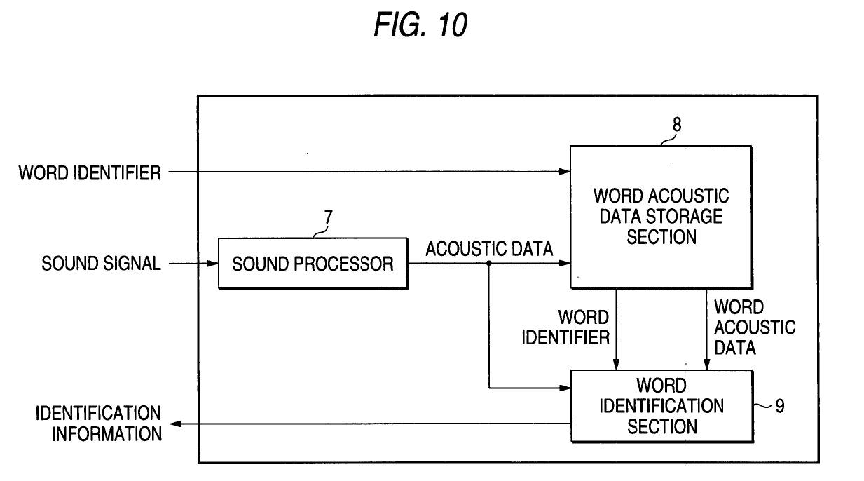

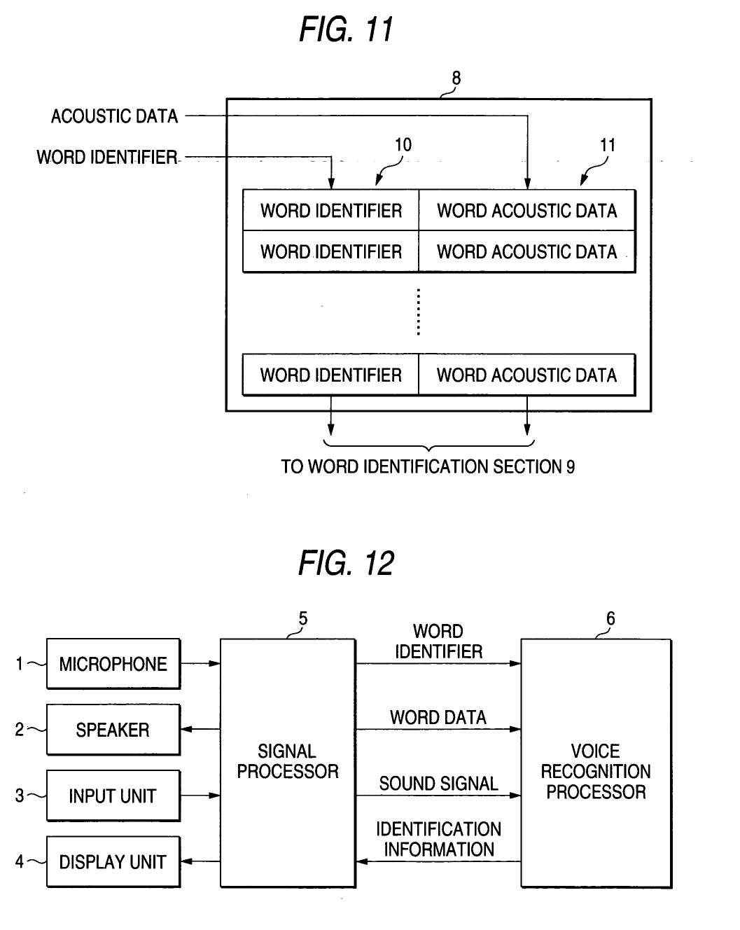

While apparatus using the voice recognition technology is getting widespread across the world, in order to reduce manufacturing costs, a manufacturer of the apparatus must mount on the apparatus all phoneme models to support the destinations of the apparatus so as to allow selection of a phoneme model which conforms to the target language by way of the key operation of the user. As the voice recognition technology and voice synthesis technology get more and more sophisticated, it is expected that apparatus without any keys (apparatus without an input unit) will emerge. This will oblige the manufacturer to mount a phoneme model to suit a particular destination on the apparatus. This adds to manufacturing costs. To solve the problem, this embodiment allows automatic language selection where a specific word per destination is previously stored in the word dictionary storage section 12 and the phoneme model storage section 13 is controlled from the signal processor, thereby it enables to automatically select a language with first utterance that the user utters before using the apparatus. This operation is described below referring to FIG. 8.

FIG. 8 is a block diagram showing voice recognition apparatus according to Embodiment 15 of the invention. Configuration in FIG. 8 differs from that in FIG. 1 in that the input unit 3 in FIG. 1 is not included.

When voice recognition apparatus has been shipped as a product and not yet used by the speaker, there is generally no data in the word dictionary storage section 12. Phoneme data of each country are stored in each phoneme model. In this embodiment, arbitrary words having the same meaning in respective languages, for example, “Ichi” in Japanese, “One” in English, and “Eine” in German, are stored before shipment of the product. The speaker (user), receiving the product, inputs a word corresponding to “Ichi” in Japanese with the language of each country from the microphone 1 to repeat the operation described earlier. The identification information on which language is selected is output from the word identification section 9 and input to the signal processor 5. The signal processor 5 outputs a control signal to the phoneme model storage section 13. The phoneme model storage section 13 closes the gates of the sections other than the section where a phoneme model corresponding to the target language is stored and outputs only the phoneme model corresponding to the target language. To change the language, inputting a specific word in a selected language triggers a series of operation to cause the signal processor 5 to output a control signal, which opens the gates for all languages in the phoneme model storage section 13 thus allowing change of language.

In this way, it is possible to provide voice recognition apparatus which allows selection of language even on apparatus without an input unit.

What is claimed is:

1. A voice recognition apparatus comprising:
an input unit for inputting a voice uttered by a speaker;
a signal processor for splitting a sound signal input by said input unit to generate acoustic data;
a language model generation and storage section for storing a plurality of phoneme models; and
a voice recognition processor for comparing the generated acoustic data with a plurality of word acoustic data stored in said language model generation and storage section and outputting identification information including a word identifier of matching word acoustic data as a result of voice recognition; and
a display unit for displaying the recognition result,
wherein said voice recognition processor sequentially compares acoustic data split by said signal processor with the word acoustic data generated from the phoneme model stored in said language model generation and storage section, and stores the word identifier of the word acoustic data corresponding to the generated acoustic data, which match the word acoustic data, as a training signal.

2. The voice recognition apparatus according to claim 1, wherein
said voice recognition processor outputs word data corresponding to the name of the distant party who calls in progress and a word identifier to distinguish the word to said language model generation and storage section, outputs an acoustic data identifier with high degree of coincidence and acoustic data corresponding to the acoustic data identifier to said language model generation and storage section, and stores the generated acoustic data which are united in the form of a sequence of data in time.

3. The voice recognition apparatus according to claim 1, wherein
said signal processor comprises a memory section for storing words which precedes and follows the name, wherein
the word which precedes the name is assumed as a start signal and the word which follows the name is assumed as an end signal.

4. The voice recognition apparatus according to claim 3, wherein
said signal processor stores a dead space which exists before the name in Japanese without exception in the memory section and detects the dead space to assume the dead space as a start signal.

5. The voice recognition apparatus according to claim 4, wherein
said signal processor comprises a detector section for detecting a dead space and a controller for assuming the detected dead space as a start signal.

6. The voice recognition apparatus according to claim 5, wherein
said signal processor provides a threshold level for detecting a dead space in said detector section.

7. The voice recognition apparatus according to claim 1, wherein
said voice recognition processor separately stores first section of a word and remaining section of the word into a word dictionary storage section and groups together words beginning with said first section.

8. The voice recognition apparatus according to claim 7, wherein
said voice recognition processor previously generates a word acoustic data of a first character from the first section in said word dictionary storage section and the phoneme model to store to the language model generation and storage section.

9. The voice recognition apparatus according to claim 7, wherein
said voice recognition processor splits a word dictionary into blocks of a first character, a family name and a first name.

10. A voice recognition apparatus comprising:
an input unit for inputting a voice uttered by a speaker;
a signal processor for splitting a sound signal input by said input unit to generate acoustic data;
a language model generation and storage section for storing a plurality of phoneme models; and
a voice recognition processor for comparing the generated acoustic data with a plurality of word acoustic data stored in said language model generation and storage section and outputting identification information including a word identifier of matching word acoustic data as a result of voice recognition; and
a display unit for displaying the recognition result,
wherein said voice recognition processor sequentially compares word acoustic data stored in said language model generation and storage section and acoustic data generated from a name uttered by the speaker and gives a frequency “1” to word acoustic data having the highest degree of coincidence output from a word identification section when used for each word acoustic data stored in said language model generation and storage section, and adds up each time of using to perform weighting.

11. The voice recognition apparatus according to claim 10, wherein
said voice recognition processor uses only word acoustic data whose frequency is equal to or higher than an arbitrary degree to perform recognition operation.

12. The voice recognition apparatus according to claim 10, wherein
said voice recognition processor splits word acoustic data into blocks of arbitrary number of words in the descending order of use frequency, outputs word acoustic data of block of which use frequency is high, and displays block by block.

13. The voice recognition apparatus according to claim 10, wherein
said signal processor has a clock function and said voice recognition processor provides a time limit for calculating the use frequency based on a time reported from said signal processor.

14. The voice recognition apparatus according to claims 1, wherein
said signal processor, in a case that the result displayed on the display unit after recognition operation differs from a result the user intends, stores a information showing the difference into a built-in memory, and skips the display of a word once erroneously recognized based on the information showing the difference in a case that the same word is uttered.

15. The voice recognition apparatus according to claims 1, wherein
said signal processor, in a case that the result displayed on the display unit after recognition operation differs from a result the user intends, stores a information showing the difference into a memory section of said voice recognition processor, and skips the display of a word once erroneously recognized based on the information showing the difference in a case that the same word is uttered.

16. A voice recognition apparatus comprising:
an input unit for inputting a voice uttered by a speaker;
a signal processor for splitting a sound signal input by said input unit to generate acoustic data;
a language model generation and storage section for storing a plurality of phoneme models; and
a voice recognition processor for comparing the generated acoustic data with a plurality of word acoustic data stored in said language model generation and storage section and outputting identification information including a word identifier of matching word acoustic data as a result of voice recognition; and
a display unit for displaying the recognition result,
wherein said language model generation and storage section stores a specific word of each country into a word dictionary storage section.
